(19) United States
(12) Patent Application Publication
(10) Pub. No.: US 2011/0261676 A1
(43) Pub. Date: Oct. 27, 2011

(54) CM/PAPR REDUCTION FOR LTE-A DOWNLINK WITH CARRIER AGGREGATION

(75) Inventors: Yiqing ZHOU, Hong Kong (HK); Zhengang PAN, Hong Kong (HK)

(73) Assignee: HONG KONG APPLIED SCIENCE AND TECHNOLOGY RESEARCH INSTITUTE COMPANY LIMITED, Hong Kong (HK)

(21) Appl. No.: 12/764,215

(22) Filed: Apr. 21, 2010

(51) Int. Cl. H04J 11/00; H04W 72/04

(52) U.S. Cl. 370/210; 370/329

(57) ABSTRACT

The present invention relates to the reduction of the CM and PAPR of an LTE-A downlink signal after carrier aggregation. The CM and PAPR of the aggregated signal are reduced by introducing cyclic time shifts to the OFDM symbols in each of the component carriers (CC). Out of all the aggregated CCs, one of them is chosen to have zero cyclic time shift, meanwhile an optimal amount of cyclic time shifts is introduced into each of the other aggregated CCs. The optimal cyclic time shift for each CC is calculated by applying every possible shift value to all of the OFDM symbols in that CC and working out for each case the CM value when the OFDM signal of that CC is combined with those in other shifted CCs. For each CC, the optimal cyclic time shift is the amount of cyclic shifts applied to that CC which would give the lowest peak “combined CM value”.

### FIELD OF THE INVENTION

The invention relates to LTE-Advanced (LTE-A) wireless communication systems and, more particularly, to the reduction of the resulting cubic metric (CM) and peak to average power ratio (PAPR) of the downlink signal after the aggregation of two or more component carriers (CC).

### BACKGROUND

The 3^{rd} Generation Partnership Project (3GPP) Long Term Evolution (LTE) is a highly flexible radio interface with initial deployments expected in 2010. As the work on the first release of the LTE standard is coming to an end, the focus is now gradually shifting towards the further evolution of LTE, referred to as LTE-Advanced (LTE-A). One of the goals of this evolution is to reach and even surpass the requirements on IMT-Advanced, which is currently being defined by the International Telecommunication Union Radiocommunication Sector (ITU-R). These requirements will include further significant enhancements in terms of performance and capability compared to the current cellular systems, including the first release of LTE.

More information on LTE and LTE-A can be found in Rumney, LTE and the Evolution of 4G Wireless, John Wiley, ©2009, and Sesia, LTE: The UMTS Long Term Evolution, Wiley ©2009, and the standard documents for E-UTRA: 3GPP TS 36.211: “Evolved Universal Terrestrial Radio Access (E-UTRA); Physical channels and modulation;” 3GPP TS 36.212: “Evolved Universal Terrestrial Radio Access (E-UTRA); Multiplexing and channel coding;” 3GPP TS 36.213: “Evolved Universal Terrestrial Radio Access (E-UTRA); Physical layer procedures”, 3GPP TR36.913: “Requirements for further advancements for E-UTRA (LTE-Advanced)”, 3GPP TS36.104: “Base Station (BS) radio transmission and reception” and 3GPP TR25.913: “Requirements for Evolved UTRA (E-UTRA) and Evolved UTRAN (E-UTRAN)”, the disclosures of which are incorporated by reference herein.

IMT-Advanced is the term used by the ITU for radio-access technologies beyond IMT-2000, and an invitation to submit candidate technologies for IMT-Advanced has been issued by the ITU. In September 2009, the 3GPP Partners made a formal submission to the ITU proposing that LTE Release 10 and beyond (LTE-A) be evaluated as a candidate for IMT-Advanced.

The requirements for LTE-A include the support of larger transmission bandwidths than in LTE. Moreover, there should be backward compatibility so that LTE user equipment (UE) can work in LTE-A networks. A direct consequence of this requirement is that, for an LTE terminal, an LTE-A-capable network should appear as an LTE network. Such spectrum compatibility is of critical importance for a smooth, low-cost transition to LTE-A capabilities within the network, and is similar to the evolution of WCDMA to HSPA. Apart from the requirement on backward compatibility, LTE-A should also fulfill, or even surpass, all the IMT-Advanced requirements in terms of capacity, data rates and low-cost deployment, and this includes the possibility for peak data rates of up to 1 Gbit/s in the downlink and 500 Mbit/s in the uplink. Most importantly, these high data rates can be provided over a larger portion of the cell.

The very high peak data rate targets for LTE-A can only be fulfilled in a reasonable way with a further increase from the 20 MHz transmission bandwidth that is supported by the first release of LTE, and currently transmission bandwidths of up to 100 MHz have been discussed in the context of LTE-A. At the same time, such a bandwidth extension should be done while preserving spectrum compatibility. This can be achieved with so-called “carrier aggregation”, where multiple LTE component carriers (CC) are aggregated on the physical layer to provide the necessary bandwidth; the component carriers may occupy contiguous or discontiguous bandwidth regions. To an LTE terminal, each CC will appear as an LTE carrier, while an LTE-A terminal can exploit the total aggregated bandwidth.

Carrier aggregation is one of the main features of LTE-A to support wider bandwidths than that of LTE. A problem with carrier aggregation is that as the number of aggregated CCs is increased, the downlink peak to average power ratio (PAPR) and cubic metric (CM), which will be discussed in the next paragraph, would also increase due to the repeated downlink reference signal sequence (RSS) across the CCs.

The cubic metric (CM) is a method that was introduced in 3GPP Release 6 for estimating the amplifier power reduction. The CM value is based on the amplifier cubic gain term, and it describes the ratio of the cubic components in the observed signal to the cubic components of a 12.2 kbps voice reference signal.

The problem with signals having a high CM or PAPR is that they require highly linear power amplifiers to avoid excessive inter-modulation distortion. In order to achieve this linearity, the amplifiers have to operate with a large backoff from their peak power, and the result is low power efficiency. The request for high power efficiency is usually released for an uplink transmission from a User Equipment (UE). However, recently, Green Radio is widely discussed, which aims to reduce the power consumption of information communication technologies (ICT) and makes ICT environmental friendly. Therefore, the CM and PAPR of a signal should be minimized for a downlink transmission as well.

In reference documents R1-083706, “DL/UL Asymmetric Carrier aggregation”, Huawei and R1-084195, “Issues on the physical cell ID allocation to the aggregated component carriers”, LG Electronics, it is observed that if the same physical cell identifier (also known as physical cell ID or PCI) is allocated to all the CCs within a cell, the CM and PAPR values for the downlink transmission will be quite large. This is because under the current pseudo-random reference signal sequence (RSS) generating method, the final RSS is decided by the PCI. If the PCI is the same for all the component carriers, using the current initialization method, the RSS for each CC will also be exactly the same when the CCs have the same bandwidth. Then the overall RSS across all the CCs will be a periodic sequence.

Due to the property of IFFT and the fact the total RSS is a periodic sequence, for a number of CCs that have been aggregated, the output sequence of the IFFT will have only one nonzero symbol with all the others strictly zero when the component carriers are equally spaced and with the same bandwidth. Because of the multiple zeros in the downlink signals, the CM and PAPR values of the transmitted signal will be extremely high, and this, as discussed earlier, is a situation that needs to be avoided.

There are a number of existing schemes which aims to tackle the problem of increased CM or PAPR resulted from carrier aggregation. One of them is to assign a different physical cell ID (PCI) to each of the CCs. As the repeated RSS is caused by all CCs having the same PCI, if a distinct PCI is assigned to each CC, the reference signal sequences would also be distinct, and the CM increase problem would not happen. However, PCI allocation is related to the basic design of an LTE-A system such as initial access and control channel allocation, and so backward compatibility issues with LTE may arise.

A second existing scheme is to apply phase offsets to the CCs, under which each CC can be transmitted with a potentially different phase offset. With this alternative, the cubic metric may be reduced up to the point where it poses no problem, and there will not be any problems with backward compatibility, but it is only effective for some special forms of carrier aggregation, such as when the CCs are equally spaced and with the same bandwidth. Another drawback is that it is ineffective for the case when exactly two component carriers are aggregated.

A third existing scheme is to apply different cyclic time shifts between the CCs. With the application of different cyclic time shifts, the borders of the radio frame of each CC can be kept same, and the cyclic time shift can be done by applying a different linear phase offset to each CC in the frequency domain before the inverse fast Fourier transform (IFFT) is performed. Moreover, backward compatibility issues will not arise since the time shift is only of a few time samples and is within the tolerance for the timing error. However, since the cyclic time shift is small, the reduction in the CM and PAPR from using this method is not so significant.

Thus, there remains a need in the art for a backward compatible and yet effective method for reducing the CM and PAPR of a downlink transmission signal upon carrier aggregation.

### SUMMARY OF THE INVENTION

The present invention relates to the reduction of the resulting cubic metric (CM) and peak to average power ratio (PAPR) of the downlink signal upon the aggregation of two or more component carriers (CC). As mentioned in the previous section, the high CM and PAPR values after carrier aggregation (CA) are mainly due to the repetition of the reference signal sequence (RSS). The present invention aims to minimize such repetition by employing an optimized cyclic time shift to the orthogonal frequency-division multiplexing (OFDM) symbols within each of the CCs.

Compared to the existing CM/PAPR reduction scheme that employs cyclic time shifts, the amount of cyclic time shifts that is applied in the present invention is not fixed and the amount of allowable cyclic time shifts is also greater. This greater amount of cyclic time shifts provides a more effective solution to minimize the CM and PAPR of the downlink signal upon carrier aggregation, meanwhile backward compatibility with LTE CCs can still be incorporated if such consideration is important at the time of implementation. The amount of cyclic time shifts that would minimize the CM and PAPR of the downlink signal (i.e. the “optimal cyclic time shift”) are calculated by a specific algorithm which will be disclosed in detail herein, and the calculated optimal cyclic time shifts will then be applied to all of the aggregated CCs that need to be cyclic shifted.

### BRIEF DESCRIPTION OF THE DRAWINGS

FIG. 1 schematically depicts the frame structure of an LTE-A downlink signal with a normal cyclic prefix.

FIG. 2 schematically depicts the structure of an OFDM signal within a component carrier (CC).

FIG. 3 is a flow chart showing the procedures for calculating the optimal cyclic time shifts for N component carriers (CCs), where N is the total number of CCs.

FIG. 4 schematically depicts the base station and user equipment that are involved in an LTE-A signal transmission

### DETAILED DESCRIPTION

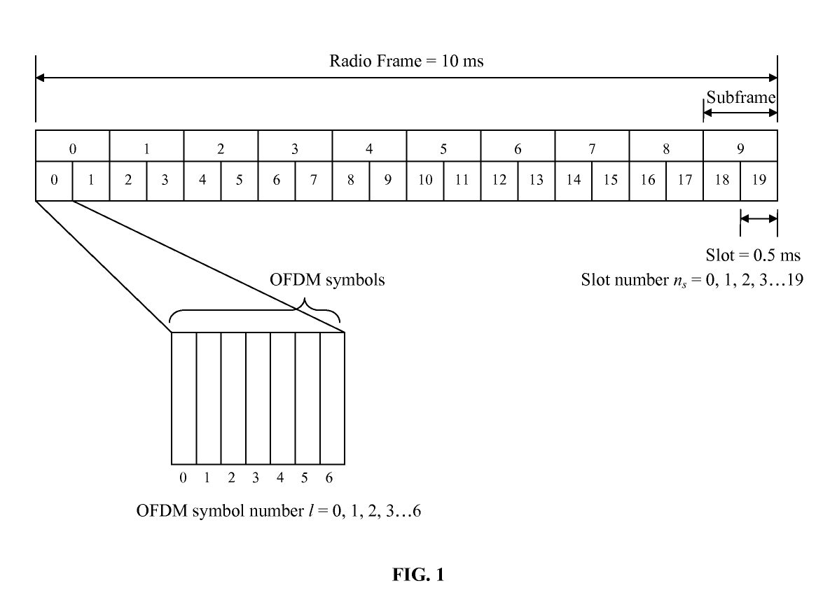

The present invention provides an improved method and apparatus for minimizing the cubic metric (CM) and peak to average power ratio (PAPR) of an LTE-A downlink signal upon carrier aggregation. In FIG. 1, the frame structure of an LTE-A downlink signal with a normal cyclic prefix is depicted.

This invention is an improvement over the existing scheme which employs cyclic time shifts. The cyclic time shifts are introduced into the component carriers (CC) to destroy the repetition pattern in the reference signal sequences (RSS). Under the existing scheme, the amount of cyclic time shift is fixed and is kept small. This ensures that every LTE-A CC is backward compatible with LTE, however the reduction in the CM and PAPR of the downlink signal after carrier aggregation is not very effective.

The present invention employs an optimized amount of cyclic time shifts which minimizes the CM and PAPR after carrier aggregation. This optimized amount of cyclic time shifts is more effective in minimizing the CM and PAPR of the downlink signal after carrier aggregation compared to the existing scheme, while still maintaining the backward compatibility with LTE. In addition, this invention also discloses a method for calculating and applying the optimal cyclic time shifts when backward compatibility is no longer an important consideration, e.g. when LTE is being phased out in favor of LTE-A.

During the early stages of LTE-A implementation, i.e. when all the CCs should be backward compatible with LTE, the CM and PAPR after carrier aggregation are minimized by the method described hereinafter.

Firstly, out of all the CCs that will be aggregated, one of them is kept with zero shift while the optimal amount of cyclic time shift for each of the other CCs is applied to their corresponding OFDM symbols. The CC to be kept with zero shift can be chosen in a number of ways, for example, at random or by choosing the CC with the lowest carrier frequency. The value of the cyclic time shift applied should be negative (i.e. left-shifted), and the amount must not be larger than the tolerance D_{L}, which is given by:

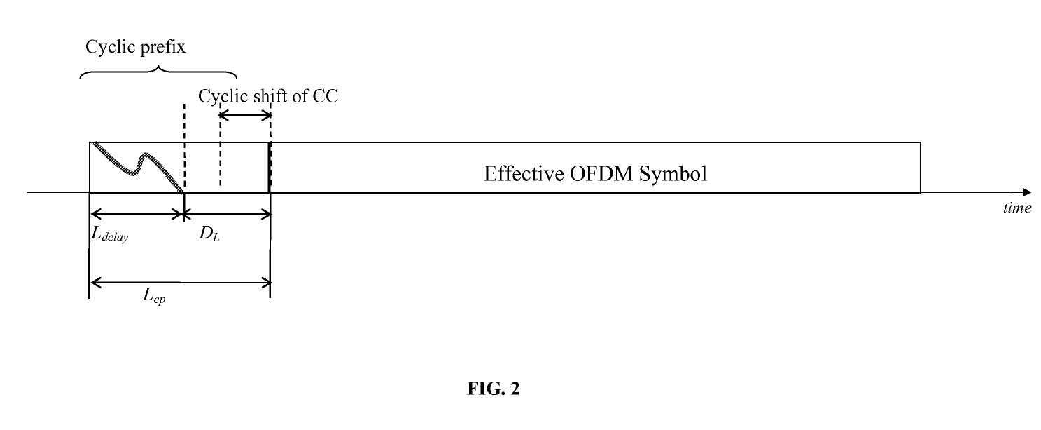

D_{L}=L_{cp}−L_{delay},

where L_{cp} is the length of the cyclic prefix and L_{delay} is the maximum delay of the channel. The value of L_{cp} will be given in the forthcoming LTE-A standard, while the value of L_{delay} will be available once the cell-planning is carried out by the telecommunication operators. Several methods can be used to measure the value of L_{delay} in a field test, such as using an impulse measurement, a spread spectrum slide correlator measurement and a frequency domain channel measurement. In impulse measurement, a single narrow impulse is sent from the transmitter. At the receiver, plural impulses will be obtained due to the multipath delay. The value of L_{delay} is the maximum delay spread of the received impulses. The relations between D_{L}, L_{cp} and L_{delay} are illustrated in FIG. 2. As mentioned earlier, since the amount of cyclic time shifts is kept within the tolerance for the timing error, all the time-shifted CCs will be backward compatible with the LTE system.

During the later stages of LTE-A implementation, i.e. when backward compatibility with LTE is no longer an important consideration, the same method as described in the previous paragraph will be implemented, but the value of D_{L} will become the length of the fast Fourier Transform (FFT) of the OFDM signal.

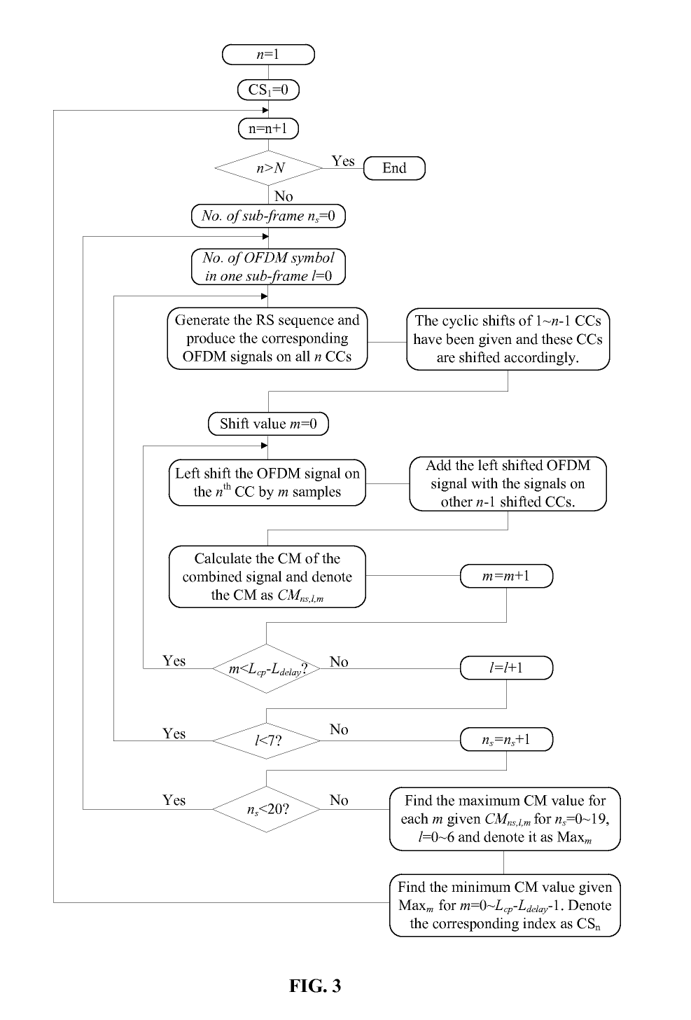

The method for calculating the optimal cyclic time shift (i.e. the cyclic time shift that minimizes the CM and PAPR after carrier aggregation) is illustrated in FIG. 3 and is described in detail hereinafter.

In LTE and LTE-A, each OFDM downlink radio frame is divided into 20 slots (each 0.5 ms wide), and each of these slots is further divided into 7 OFDM symbols. When the optimal cyclic time shift is to be calculated for a CC (the “current CC”), both the slot number nₛ, which ranges from 0 to 19, and the OFDM symbol number l, which ranges from 0 to 6, will initially be set to zero. With these initial values, the RSS which corresponds to this specific cell and (nₛ, l) location on the radio frame is generated, and the corresponding OFDM signals are produced on all N of the CCs, where Nis the number of CCs being aggregated. Currently, bandwidths of up to 100 MHz as a result of carrier aggregation are being discussed. Given that each LTE component carrier has a bandwidth of 20 MHz, this is equivalent to the aggregation of up to five CCs, and so the value of N would be any integer between 1 and 5. The OFDM symbols in each of the CCs are then cyclic shifted according to their optimal cyclic time shift value. Regarding those CCs for which the optimal cyclic time shifts have not been calculated, no cyclic time shifts will be applied to them at all. Moreover, out of all the aggregated CCs, one of them will be chosen to always be kept with zero cyclic time shift.

Afterwards, the calculation of the optimal cyclic time shift for the current CC is continued by applying to its OFDM symbols different cyclic time shift values m, where m ranges from 0 to D_{L} (as previously defined). For each value of m, the OFDM symbol at the specified (nₛ, l) location on the current CC is left-shifted by m samples, then that left-shifted OFDM symbol is added to the corresponding OFDM symbols (i.e. the OFDM symbols with the same (nₛ, l) location on their respective CCs) on other shifted CCs to create a “combined OFDM symbol”. Subsequently, the CM value of the combined OFDM symbol (hereinafter referred to as the “combined CM value”) is calculated and is denoted as CM_{ns,l,m}. After all of the possible m values have been used for a given (nₛ, l) location, the above processes of:
(i) generating the RSS for the specified (nₛ, l) location and producing the corresponding OFDM symbols (optimally shifted if necessary) on all of the n CCs;
(ii) left-shifting the OFDM symbol on the current CC by m samples;
(iii) combining that left-shifted OFDM symbol with the rest of the corresponding OFDM symbols; and
(iv) calculating and recording the CM value of the combined signal; are repeated iteratively for all possible values of l, and thereafter all possible values of nₛ, until the combined CM value have been evaluated for all of the 140 (nₛ, l) locations and with every possible value of m. When all the combined CM values for the current CC have been evaluated, the peak CM value for each m is then identified and is denoted as Maxₘ. Afterwards, out of all the Maxₘ values for the current CC, the minimum value is identified and the corresponding value of m is recorded as CSₙ. Then repeat the steps for finding the optimal cyclic time shift for the current CC on the rest of the aggregated CCs.

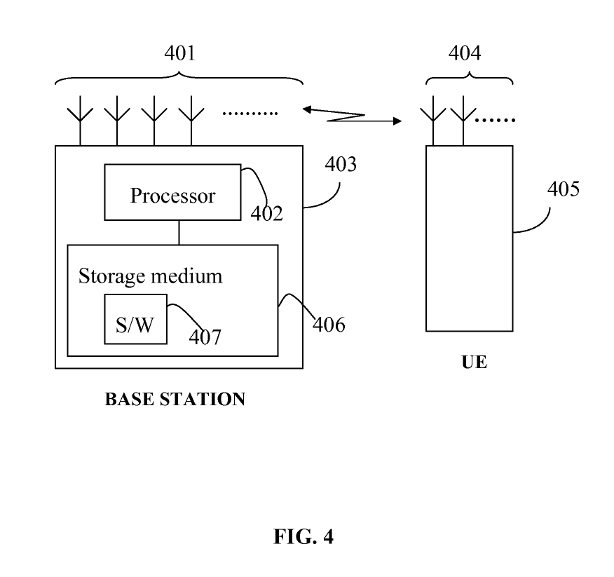

Once all of the optimal cyclic time shifts have been calculated, they are applied to each of the CCs. A schematic depiction of an LTE-A system which includes formation of signals with optimal cyclic time shifts is shown in FIG. 4. A base station/eNodeB 403 includes processor 402 which includes software 407 embedded on a non-transitory computer readable storage medium 406. Upon executing the software 407, the processor 402 performs some, or all, of the functionality described herein. The computer readable storage medium 406 preferably comprises volatile memory (e.g., random access memory), non-volatile storage (e.g., hard disk drive, CD ROM, read only memory, etc.), or combinations thereof. The base station 403 generates the CCs having the optimal cyclic time shifts according to the processes set forth above. The CCs are aggregated and transmitted via antenna 401 from the base station 403 to receiving user equipment 405 via user equipment antenna 404.

While the foregoing invention has been described with respect to various embodiments, it is understood that other embodiments are within the scope of the present invention as expressed in the following claims and their equivalents.

What is claimed is:

1. In an LTE-A wireless communication system, a method for reducing the cubic metric (CM) and peak to average power ratio (PAPR) of a downlink signal after the aggregation of two or more component carriers by introducing cyclic time shifts to OFDM symbols in each of the component carriers comprising:
selecting, by a processor in a base station, a first component carrier to have zero cyclic time shift;
determining an optimal amount of cyclic time shift in each of the other aggregated component carriers by applying every possible shift value to all of the OFDM symbols in each of the other aggregated component carriers and determining for each case the CM value when the OFDM signal of each component carrier is combined with other shifted component carriers, wherein for each component carrier, the optimal cyclic time shift is the amount of cyclic shift applied to that component carrier which, when aggregated with other shifted component carriers, produces the lowest peak combined CM value of the aggregated signal;
applying the optimal time shift to the aggregated component carriers; and
sending the downlink signal comprising the aggregated component carriers from the base station to receiving user equipment.

2. A method for reducing the cubic metric (CM) and peak to average power ratio (PAPR) of a downlink signal in an LTE-A wireless communication system as set forth in claim 1 wherein the value of the cyclic time shift applied is less than the tolerance D_{L}, which is given by:
D_{L}=L_{cp}−L_{delay},
where L_{cp} is the length of a cyclic prefix of an OFDM symbol and L_{delay} is the maximum delay of a channel.

3. A method for reducing the cubic metric (CM) and peak to average power ratio (PAPR) of a downlink signal in an LTE-A wireless communication system as set forth in claim 2 wherein the tolerance D_{L} is equal to the length of a fast Fourier Transform (FFT) of the OFDM signal.

4. A method for reducing the cubic metric (CM) and peak to average power ratio (PAPR) of a downlink signal in an LTE-A wireless communication system as set forth in claim 1 wherein each component carrier has a bandwidth of up to 20 MHz.

5. A method for reducing the cubic metric (CM) and peak to average power ratio (PAPR) of a downlink signal in an LTE-A wireless communication system as set forth in claim 1 wherein up to five component carriers are aggregated.

6. A method for reducing the cubic metric (CM) and peak to average power ratio (PAPR) of a downlink signal in an LTE-A wireless communication system as set forth in claim 1 wherein the component carriers occupy contiguous spectral regions.

7. A method for reducing the cubic metric (CM) and peak to average power ratio (PAPR) of a downlink signal in an LTE-A wireless communication system as set forth in claim 1 wherein the component carriers occupy discontiguous spectral regions.

8. An LTE-A wireless communication system comprising:
a base station having a processor for introducing cyclic time shifts to OFDM symbols in component carriers to be aggregated, the processor including software encoded on a non-transitory computer readable storage medium for selecting a first component carrier to have zero cyclic time shift, determining an optimal amount of cyclic time shift in each of the other component carriers to be aggregated by applying every possible shift value to all of the OFDM symbols in each of the other component carriers to be aggregated and determining for each case the CM value when the OFDM signal of each component carrier is combined with other shifted component carriers, wherein for each component carrier, the optimal cyclic time shift is the amount of cyclic shift applied to that component carrier which, when aggregated with other shifted component carriers, produces the lowest peak combined CM value of an aggregated signal;
the base station being configured to apply the calculated optimal time shifts to respective component carriers and aggregating the component carriers;
one or more antennas for transmission of the aggregated component carriers to receiving user equipment.

9. An LTE-A wireless communication system according to claim 8 wherein the value of the cyclic time shift applied is less than the tolerance D_{L}, which is given by:
D_{L}=L_{cp}−L_{delay},
where L_{cp} is the length of a cyclic prefix of an OFDM symbol and L_{delay} is the maximum permissible delay of a channel.

10. An LTE-A wireless communication system according to claim 9 wherein the tolerance D_{L} is equal to the length of a fast Fourier Transform (FFT) of the OFDM signal.
